(19) United States
(12) Patent Application Publication
(10) Pub. No.: US 2009/0259793 A1
(43) Pub. Date: Oct. 15, 2009

(54) System and method for effectively implementing an erase mode for a memory device

(75) Inventor: Yosuke Muraki, Campbell, CA (US)

Correspondence Address: Gregory J. Koerner;Redwood Patent Law, 1291 East Hillsdale Boulevard, Suite 205, Foster City, CA, 94404, US

(73) Assignee: Sony Corporation and Sony Electronics Inc.

(21) Appl. No.: 12/082,519

(22) Filed: Apr. 10, 2008

(51) Int. Cl. G06F 12/00

(52) U.S. Cl. 711/100; 711/E12.001

(57) ABSTRACT

A system and method for effectively implementing an erase mode for a memory device includes a memory array that is configured to temporarily store confidential or other types of data. A mode switch is provided on the memory device for permitting a device user to readily select between a normal mode and the erase mode for the memory device. A memory controller of the memory device contemporaneously or subsequently erases the data from the memory array if the erase mode has been activated by the mode switch.

### BACKGROUND SECTION

1. Field of the Invention

This invention relates generally to techniques for implementing memory devices, and relates more particularly to a system and method for effectively implementing an erase mode for a memory device.

2. Description of the Background Art

Implementing effective methods for utilizing memory devices is a significant consideration for designers and manufacturers of contemporary electronic entertainment systems. However, effectively utilizing memory devices may create substantial challenges for system designers. For example, enhanced demands for increased system functionality and performance may require additional hardware resources. An increase in hardware requirements may also result in a corresponding detrimental economic impact due to increased production costs and operational inefficiencies.

Furthermore, enhanced device capability to perform various advanced operations may provide additional benefits to a system user, but may also place increased demands on the control and management of various device components. For example, an enhanced memory device that effectively supports exchange of proprietary data may benefit from an effective implementation because of the confidential nature of the data involved.

Due to growing demands on device resources and data confidentiality concerns, it is apparent that developing new techniques for implementing and utilizing memory devices is a matter of concern for related electronic technologies. Therefore, for all the foregoing reasons, developing effective techniques for implementing and utilizing memory devices remains a significant consideration for designers, manufacturers, and users of contemporary electronic systems.

### SUMMARY

In accordance with the present invention, a system and method are disclosed for effectively implementing an erase mode for a memory device. In accordance with one embodiment of the present invention, the memory device may be implemented as a small portable memory device with a relatively large storage capacity that supports delivering confidential data to a specific event or location when the data size is too large to be easily sent as an email attachment.

However, because of the confidential nature of many types of such data, security becomes a significant concern, especially in light of the relatively small size and the increased likelihood of misplacing the memory device. The present invention therefore provides an erase mode for utilizing the memory device to support erasing stored confidential data after the confidential data has been utilized in its intended manner.

In one embodiment, data is stored in a memory array of a portable memory device by utilizing any appropriate techniques. In certain embodiments, the stored data includes confidential information. A device user then activates an erase mode in the memory device by using any effective means. For example, in certain embodiments, a mode switch may be externally accessible on the exterior of the memory device.

The device user may provide the memory device to another user or entity for transferring and utilizing the stored data with a local host computer device. The other user may then couple the memory device to the host computer by utilizing any appropriate connection technologies. An erase module of a memory controller in the memory device detects that the erase mode has currently been activated by utilizing mode switch, as discussed above.

A control circuit of the memory controller reads the stored data from the memory array of the memory device, and transfers the read data to the host computer. After the current read operation is completed, the memory array transmits a read complete signal through the control circuit to the erase module, which responsively detects the read complete signal. Finally, the erase module generates an erase command that the control circuit utilizes for triggering an erase procedure to delete the stored data from the memory array.

The security of the confidential data is therefore advantageously protected by erasing the stored data from the memory array of the memory device immediately after its intending use has been achieved. The present invention therefore provides an improved a system and method for effectively implementing an erase mode for a memory device.

### BRIEF DESCRIPTION OF THE DRAWINGS

FIG. 1 is a block diagram of a memory device and host computer, in accordance with one embodiment of the present invention;

FIGS. 2A-2D are diagrams for a first embodiment of the memory of FIG. 1, in accordance with the present invention;

FIG. 3 is a block diagram for a second embodiment of the memory of FIG. 1, in accordance with the present invention;

FIG. 4 is a block diagram for one embodiment of the memory controller of FIG. 3, in accordance with the present invention; and

FIGS. 5A-5B is a flowchart of method steps for effectively implementing an erase mode for a memory device, in accordance with one embodiment of the present invention.

### DETAILED DESCRIPTION

The present invention relates to an improvement in memory devices. The following description is presented to enable one of ordinary skill in the art to make and use the invention, and is provided in the context of a patent application and its requirements. Various modifications to the disclosed embodiments will be readily apparent to those skilled in the art, and the generic principles herein may be applied to other embodiments. Thus, the present invention is not intended to be limited to the embodiments shown, but is to be accorded the widest scope consistent with the principles and features described herein.

The present invention is described herein as a system and method for effectively implementing an erase mode for a memory device, and includes a memory array that is configured to temporarily store confidential or other types of data. A mode switch is provided on the memory device for permitting a device user to readily select between a normal mode and the erase mode for operating the memory device. A memory controller of the memory device contemporaneously or subsequently erases the stored data from the memory array if the erase mode has been activated by the mode switch.

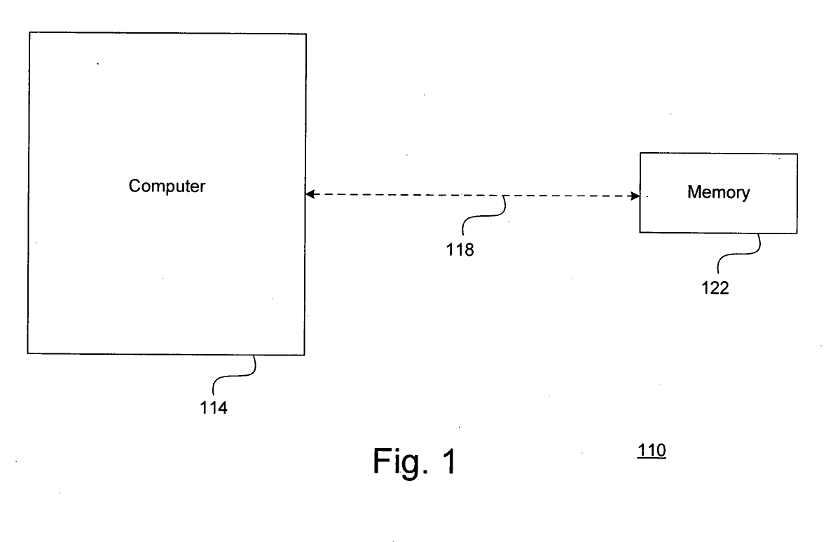

Referring now to FIG. 1, a block diagram of a memory 122 and a host computer 114 is shown, in accordance with one embodiment of the present invention. The FIG. 1 embodiment is presented for purposes of illustration, and in alternate embodiments, the present invention may readily be implemented using components and configurations in addition to, or instead of, certain of those components and configurations discussed in conjunction with the FIG. 1 embodiment.

In the FIG. 1 embodiment, memory 122 may be implemented as any appropriate type of data storage device. For example, in certain embodiments, memory 122 may be implemented as a portable memory device that may be coupled with computer 114 by utilizing any effective connection techniques. In one embodiment, memory 122 may be implemented as a non-volatile flash-memory stick that plugs directly into computer 114 using a USB connector or other appropriate connector. Alternately, computer 114 may communicate with memory 122 via wireless technology or a cable connection. In certain embodiments, memory 122 may utilize FeRAM or MRAM technology to store data in non-volatile memory.

In the FIG. 1 embodiment, computer 114 may be implemented as any portable or non-portable electronic device that is configured to write data to, and read data from, memory 122. Computer 114 may alternately be implemented as any other desired type of electronic device, entity, or system. For example, computer 114 may be implemented as a personal digital assistant, a laptop computer, a printer, a cellular telephone, a digital camera, or an electronic gaming device.

In the FIG. 1 embodiment, memory 122 may be implemented as a small portable memory device with a relatively large storage capacity that supports hand-delivering confidential data to a specific event or location when the data size is too large to be easily sent as an email attachment. However, because of the confidential nature of many types of such data, security becomes a significant concern, especially in light of the relatively small size and the increased likelihood of misplacing memory 122.

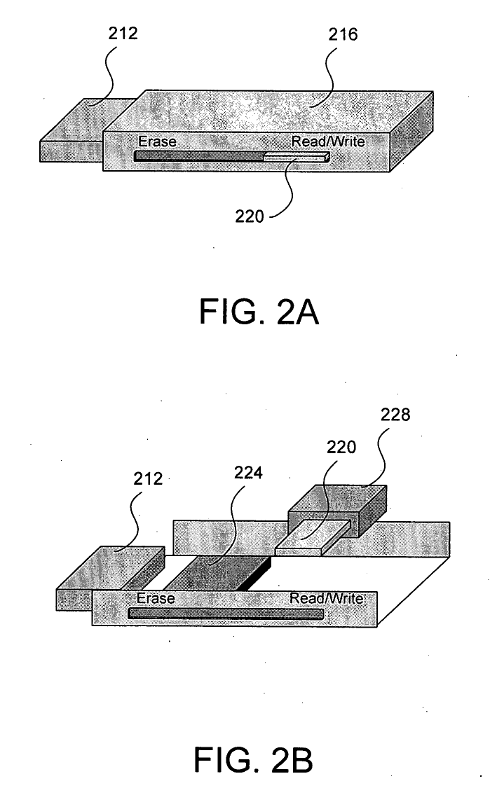

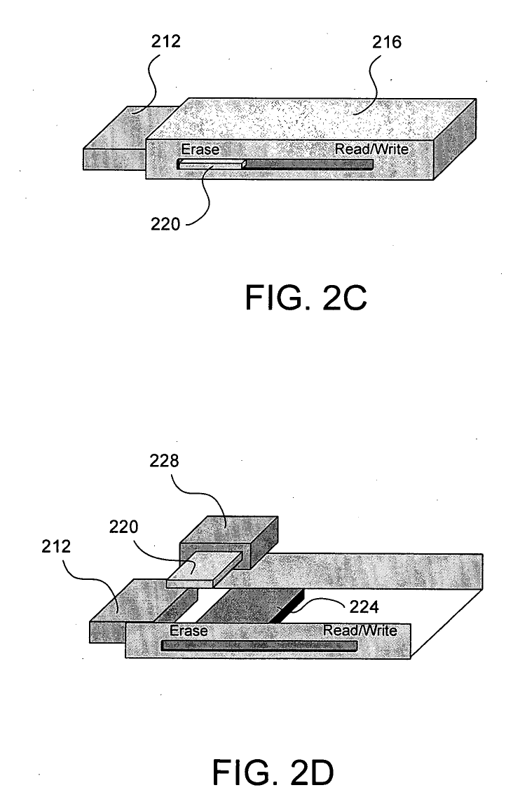

The present invention therefore provides an improved erase mode for utilizing memory 122 to advantageously support erasing stored confidential data in a user-friendly way after the confidential data has been utilized in its intended manner. The implementation and utilization of the erase mode in memory 122 is further discussed below in conjunction with FIGS. 2-5.

Referring now to FIGS. 2A-2D, diagrams for a first embodiment of the FIG. 1 memory 122 is shown, in accordance with the present invention. The FIG. 2 embodiment is presented for purposes of illustration, and in alternate embodiments, memory 122 may readily be implemented using various components and configurations in addition to, or instead of, those discussed in conjunction with the FIG. 2 embodiment.

FIGS. 2A and 2B show memory 122 in a normal read/write mode in which the erase mode is not activated. FIG. 2A is an elevation view of memory 122 with a body section 216 and a connector 212 to couple memory 122 to a host device such as computer 114 of FIG. 1. The FIG. 2A view also includes a mode switch 220 that is shown in a normal read/write position. FIG. 2B is an exploded elevation view of memory 122, and includes connector 212 and mode switch 220, as shown in corresponding FIG. 2A.

FIG. 2B also includes a non-volatile memory array 224 for storing data and an eraser unit 228 that is attached to, and controlled by, mode switch 220. In the FIG. 2B embodiment, eraser unit 228 may be implemented in any effective manner to erase the data in memory array 224 when positioned directly adjacent to memory array 224. However, in the FIG. 2B embodiment, eraser unit 228 is not positioned directly adjacent to memory unit 224 because mode switch 220 is in the normal read/write mode.

FIGS. 2C and 2D show memory 122 in an erase mode, in accordance with the present invention. FIG. 2C is an elevation view of memory 122 with a body section 216 and a connector 212 to couple memory 122 to a host device such as computer 114 (FIG. 1). The FIG. 2C view also includes mode switch 220 that is shown in an erase position. FIG. 2D is an exploded elevation view of memory 122, and includes connector 212 and mode switch 220, as shown in corresponding FIG. 2C.

FIG. 2D also includes a non-volatile memory array 224 for storing data and an eraser unit 228 that is attached to, and moveably controlled by, mode switch 220. In the FIG. 2D embodiment, eraser unit 228 may be implemented in any effective manner to erase the data in memory array 224 when positioned directly adjacent to memory array 224. For example, in certain embodiments, eraser unit 228 may include a permanent magnet that erases data stored in memory array 224 when memory array 224 is implemented as an appropriate type of ferromagnetic memory. In the FIG. 2D embodiment, a device user has utilized mode switch 220 to position eraser unit 228 directly adjacent to memory unit 224 with mode switch 220 in the erase mode. Consequently, the data stored in memory array 224 of FIG. 2D has been immediately and easily erased.

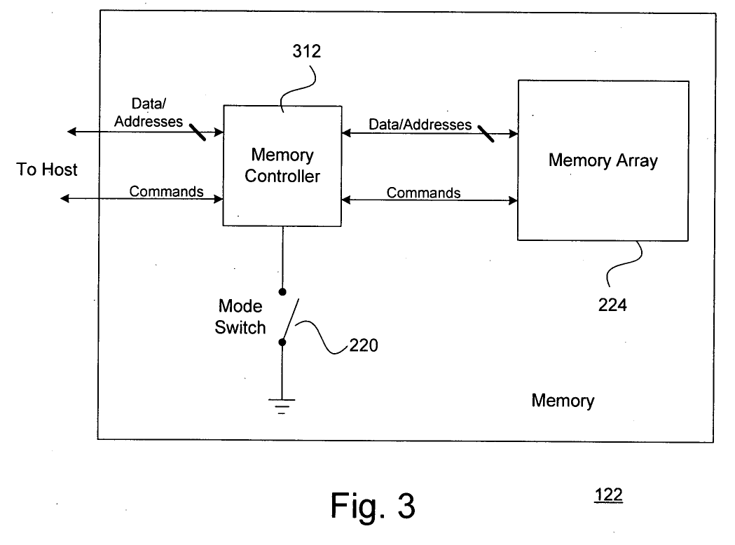

Referring now to FIG. 3, a block diagram for a second embodiment of the FIG. 1 memory 122 is shown, in accordance with the present invention. In the FIG. 3 embodiment, memory 122 preferably includes, but is not limited to, a mode switch 220, a memory array 224, and a memory controller 312. The FIG. 3 embodiment is presented for purposes of illustration, and in alternate embodiments, memory 122 may include other components or functionalities in addition to, or instead of, certain of those components or functionalities discussed in conjunction with the FIG. 3 embodiment.

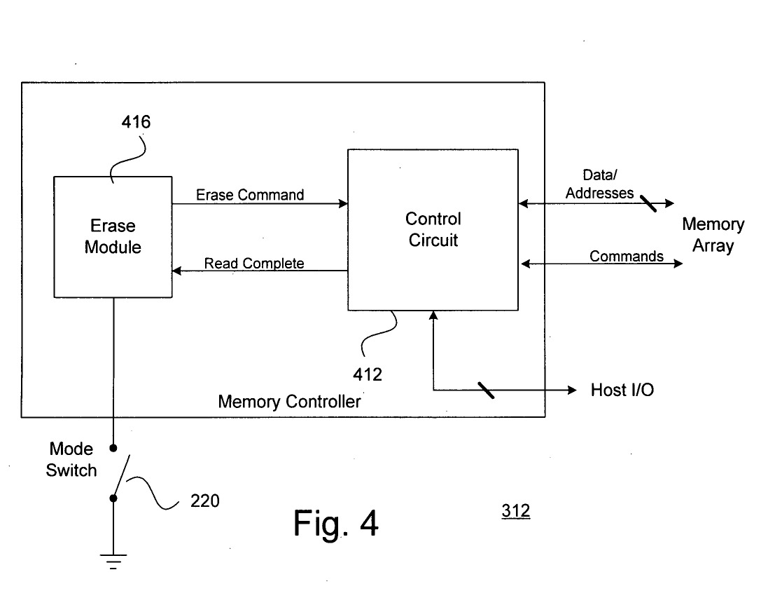

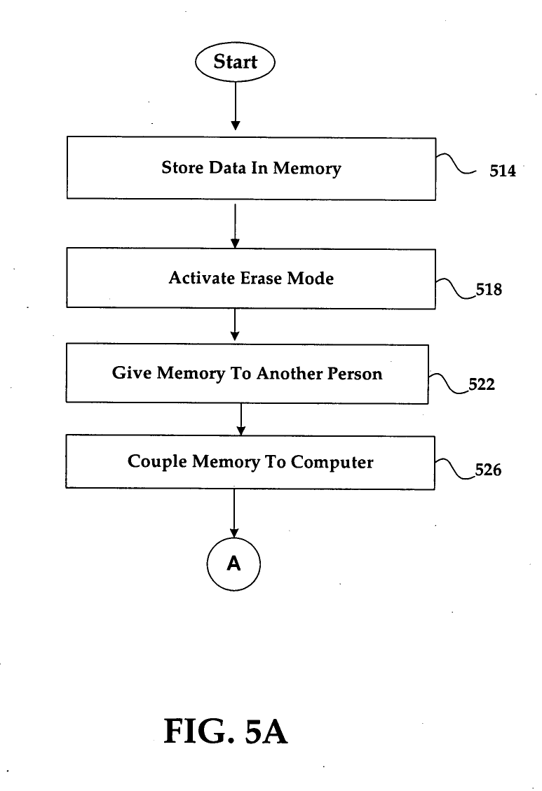

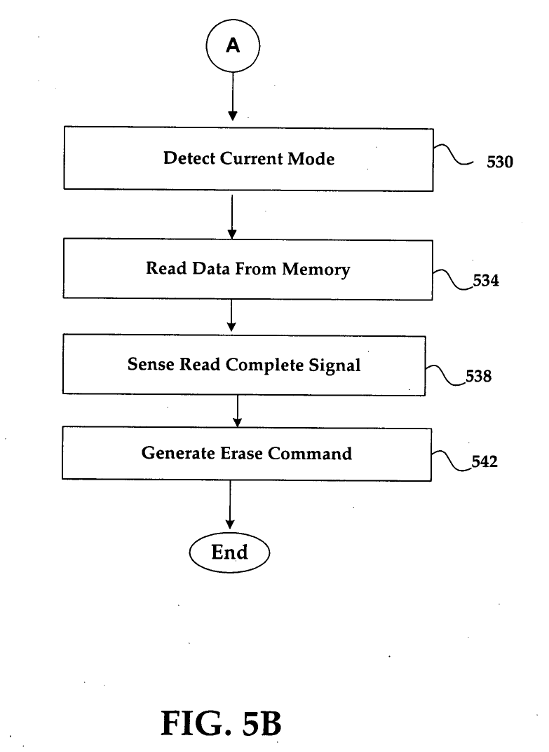

In the FIG. 3 embodiment, memory 122 bi-directionally exchanges data, addresses, and commands with a host computer 114 (FIG. 1). In particular, memory controller 312 serves as an interface between host computer 114 and memory array 224 for writing and reading data to and from memory array 224. The FIG. 3 drawing depicts a mode switch 220 that is analogous to the similarly-numbered mode switch 220 from FIG. 2, except that the FIG. 3 mode switch 220 controls an electrical switch instead of physically moving an eraser unit 228 (FIG. 2). The implementation and utilization of memory 122 are further discussed below in conjunction with FIGS. 4-5.

Referring now to FIG. 4, a block diagram of the FIG. 3 memory controller 312 is shown, in accordance with one embodiment of the present invention. In the FIG. 4 embodiment, memory controller 312 may include, but is not limited to, a control circuit 412 and an erase module 416. In alternate embodiments, memory controller 312 may be implemented using components and configurations in addition to, or instead of, certain of those components and configurations discussed in conjunction with the FIG. 4 embodiment.

In the FIG. 4 embodiment, control circuit 412 transfers data between memory array 224 (FIG. 4) and host computer 114 (FIG. 1) via a host input/output (I/O) bus in response to appropriate control commands and memory addresses. In accordance with the FIG. 4 embodiment, memory controller 312 supports an erase mode with a user-selectable number of permitted read operations. In other words, when an erase mode is activated with mode switch 220, erase module 416 will not trigger an erase procedure to delete the data stored in memory array 224 (FIG. 3) until a pre-defined number of read operations from memory array 224 have occurred.

In operation, a device user may select a desired number of allowable read operations by programming an erase register or by utilizing any other effective techniques. The number of allowed reads may be any desired number, but is typically set at one read operation. The number of allowed reads may also be set at zero, in which case, the data would be deleted as soon as the erase mode is activated.

In the FIG. 4 embodiment, memory array 224 typically notifies control circuit 412 when a given read operation is completed. Control circuit 412 then sends a read complete signal to erase module 416. When the erase mode is activated with mode switch 220, and when the total number of read complete signals equals the selected allowable number of read operations, then erase module 416 sends an erase command to control circuit 412. Control circuit 412 responsively sends an instruction to memory array 224 to immediately erase the stored data. Memory 122 thus automatically protects the security of confidential data by advantageously utilizing the foregoing erase mode.

Referring now to FIGS. 5A-5B, a flowchart of method steps for effectively implementing an erase mode for a memory device 122 is shown, in accordance with one embodiment of the present invention. The example of FIGS. 5A-5B is presented for purposes of illustration, and in alternate embodiments, the present invention may utilize steps and sequences other than those steps and sequences discussed in conjunction with the embodiment of FIGS. 5A-5B.

In step 514 of FIG. 5A, data is stored in a memory array 224 of a portable memory device 122 by utilizing any appropriate techniques. In certain embodiments, the stored data includes confidential information. In step 518, a device user activates an erase mode in memory device 122 by using any effective means. For example, in certain embodiments, a mode switch 220 may be externally accessible on the exterior of memory device 122.

In step 522, the device user may provide the memory device 122 to another user or entity for transferring and utilizing the stored data with a local host computer device 114. In step 526, the other user may then couple the memory device 122 to the host computer 114 by utilizing any appropriate connection technologies. The FIG. 5A process may then advance to step 530 of FIG. 5B through connection letter “A.”

In step 530 of FIG. 5B, an erase module 416 of a memory controller 312 detects that the erase mode has currently been activated in memory device 122 by utilizing mode switch 220, as discussed above in conjunction with step 518 of FIG. 5A. A control circuit 412 of the memory controller 312 reads the data from memory array 224 of memory device 122, and transfers the data to the host computer 114.

In step 538, after the current read operation is completed, memory array 224 transmits a read complete signal through control circuit 412 to erase module 416, which responsively detects the read complete signal. Finally, in step 542, erase module 416 generates an erase command that control circuit 412 utilizes for triggering an erase procedure to delete the stored data from memory array 224. The security of the confidential data is therefore advantageously protected by erasing the confidential data from memory device 122 immediately after its intending use has been achieved. The present invention thus provides an improved system and method for effectively implementing an erase mode for a memory device.

The invention has been explained above with reference to certain embodiments. Other embodiments will be apparent to those skilled in the art in light of this disclosure. For example, the present invention may readily be implemented using configurations and techniques other than those described in the embodiments above. Additionally, the present invention may effectively be used in conjunction with systems other than those described above. Therefore, these and other variations upon the discussed embodiments are intended to be covered by the present invention, which is limited only by the appended claims.

What is claimed is:

1. A system for implementing an erase mode for a memory device, comprising:
a memory array that is configured to temporarily store data;
a mode switch that a device user utilizes to select between a normal mode and said erase mode; and
a memory controller that erases said data from said memory array during said erase mode.

2. The system of claim 1 wherein said memory device is implemented as a portable non-volatile memory device.

3. The system of claim 1 wherein said data includes confidential information.

4. The system of claim 3 wherein said erase mode enhances security for said confidential information by preventing unauthorized entities from reading said data from said memory device.

5. The system of claim 1 wherein said data is read from said memory device by an authorized host computer before said data is deleted in said erase mode.

6. The system of claim 1 wherein said memory device is implemented as a portable flash-memory.

7. The system of claim 1 wherein said mode switch is mounted on an external surface of said memory device for ready access by said device user.

8. The system of claim 1 wherein said memory controller is mechanically implemented to include an eraser unit that is moved with said mode switch into an erase position that is directly adjacent to said memory array for deleting said data.

9. The system of claim 8 wherein said eraser unit is implemented as a permanent magnet and said memory array is implemented as a ferromagnetic memory array.

10. The system of claim 8 wherein said data is immediately erased when said device user activates said erase mode by utilizing said mode switch.

11. The system of claim 1 wherein said memory controller is implemented with electrical circuits that detect a current state of said erase switch for entering said erase mode.

12. The system of claim 11 wherein said memory controller includes a control circuit that bi-directionally transfers said data, memory addresses, and command signals between said memory array and a host computer.

13. The system of claim 12 wherein said memory controller includes an erase module that monitors said current state of said mode switch for entering said erase mode.

14. The system of claim 13 wherein said control circuit provides a read complete signal from said memory array to said erase module to indicate that a current data read operation has been completed for transferring said data from said memory device to said host computer.

15. The system of claim 14 wherein said erase module provides an erase command to said memory array in response to said read complete signal if said erase mode is activated, said memory array then immediately deleting said data.

16. The system of claim 1 wherein said erase mode is implemented to permit a user-specified number of data read operations from said memory array before said data is erased.

17. The system of claim 16 wherein said user-specified number of data read operations are stored in an erase register that is readable by said memory controller.

18. The system of claim 1 wherein said device user activates said erase mode with said mode switch, said memory device being then transferred to a second party, said memory device being coupled to a computer of said second party for reading and utilizing said data.

19. The system of claim 18 wherein an erase module from said memory controller detects said erase mode, said computer performing a read operation to access said data from said memory array, said memory array providing a read complete signal to said erase module when said read operation is complete, said erase module responsively transmitting an erase command that causes said memory array to delete said data.

20. A method for implementing an erase mode for a memory device, comprising:
providing a memory array that is configured to temporarily store data;
utilizing a mode switch to select between a normal mode and said erase mode; and
erasing said data from said memory array with a memory controller during said erase mode.
